(19) United States
(12) Patent Application Publication
(10) Pub. No.: US 2003/0121906 A1
(43) Pub. Date: Jul. 3, 2003

(54) Resistive heaters and uses thereof

(76) Inventors: Richard C. Abbott, New Boston, NH (US); Gary P. Magnant, Topsfield, MA (US); William A. Glenn, Groton, MA (US)

Correspondence Address: CLARK & ELBING LLP, 101 FEDERAL STREET, BOSTON, MA, 02110, US

(21) Appl. No.: 10/219,589

(22) Filed: Aug. 15, 2002

Related U.S. Application Data
(63) Continuation-in-part of application No. 09/996,183, filed on Nov. 28, 2001.
(60) Provisional application No. 60/253,969, filed on Nov. 29, 2000.

(51) Int. Cl. H05B 3/16

(52) U.S. Cl. 219/543

(57) ABSTRACT

The present invention features a metallic resistive heater and uses thereof. The resistive heater includes a metallic component that is electroconductive (i.e., has low resistivity) and an oxide, nitride, carbide, silicide, and/or boride derivative of the metal component that is electrically insulating (i.e., has high resistivity). The resistivity is controlled in part by controlling the amount of oxide, nitride, carbide, silicide, and boride formation during the deposition of the metal component and the derivative.

### CROSS REFERENCE TO RELATED APPLICATIONS

This application is a continuation-in-part of co-pending U.S. application Ser. No. 09/996,183, filed Nov. 28, 2001, which claims benefit from U.S. Provisional Application Serial No. 60/253,969, filed Nov. 29, 2000, each of which is hereby incorporated by reference.

### BACKGROUND OF THE INVENTION

The invention relates to the field of resistive heaters.

Thermal Spray

Thermal spray is a versatile technology for depositing coatings of metals or ceramics. It includes systems that use powder as feedstock (e.g., arc plasma, flame spray, and high velocity oxy-fuel (HVOF) systems), and systems that use wire as feedstock (e.g., arc wire, HVOF wire, and flame spray systems).

Arc plasma spraying is a method for depositing materials on various substrates. A DC electric arc creates an ionized gas (a plasma) that is used to spray molten powdered materials in a manner similar to spraying paint.

Arc wire spray systems function by melting the tips of two wires (e.g., zinc, copper, aluminum, or other metal) and transporting the resulting molten droplets by means of a carrier gas (e.g., compressed air) to the surface to be coated. The wire feedstock is melted by an electric arc generated by a potential difference between the two wires.

In flame spray, a wire or powder feedstock is melted by means of a combustion flame, usually effected through ignition of gas mixtures of oxygen and another gas (e.g., acetylene).

HVOF uses combustion gases (e.g., propane and oxygen) that are ignited in a small chamber. The high combustion temperatures in the chamber cause a concurrent rise in gas pressure that, in turn, generates a very high speed effluent of gas from an orifice in the chamber. This hot, high speed gas is used to both melt a feedstock (e.g., wire, powder, or combination thereof) and transport the molten droplets to the surface of a substrate at speeds in the range of 330-1000 m/sec. Compressed gas (e.g., compressed air) is used to further accelerate the droplets and cool the HVOF apparatus.

A thermal sprayed coating has a unique microstructure. During the deposition process, each particle enters the gas stream, melts, and cools to the solid form independent of other particles. When molten particles impact the substrate being coated, they impact (“splat”) as flattened circular platelets and freeze at high cooling rates. The coating is built up on the substrate by traversing the plasma gun apparatus repeatedly over the substrate building up layer by layer until the desired thickness of coating has been achieved. Because the particles solidify as splats, the resultant microstructure is very lamellar with the grains approximating circular platelets randomly stacked above the plane of the substrate.

Resistive Heaters

Thermal spray technology has been used to deposit a coating for use as a heater. A resistive heater produces heat by the collision of electrons with the atoms of the heater material. The rate at which heat is generated is the power, which depends on the amount of current flowing and the resistance to the current flow offered by the material. The resistance of a heater depends on a material property termed “resistivity,” and a geometric factor describing the length of the current path and the cross-sectional area through which the current passes.

Previously, resistive coatings have been deposited using thermal spray. In one such example, metal alloys such as 80% Nickel-20% Chrome are deposited and used as heaters. In another example, a metal alloy in powder form is mixed with powders of electrical insulators such as aluminum oxide prior to deposition. The blended material is then deposited using thermal spray to form a coating of resistive material. When nickel-chrome is deposited as a resistive heater, however, the bulk resistivity of the layer is still rather low, which makes it more difficult to form an element because a long path length is required to achieve a high enough resistance. When oxide-metal blends are deposited, large discontinuities in the composition of a resistive layer, which produce variations in power distribution over a substrate, are frequently present.

Injection Molding

Many plastic and metal parts, for example, aluminum automobile transmission housings or polycarbonate computer cases, are manufactured by injecting molten metal or polymer melt into a complex cavity cut into steel. Injection-molding machinery melts a thermoplastic or metal powder in a heating chamber and forces it into a mold, where it hardens. The operations take place at rigidly controlled temperatures and intervals. In an injection molding process, it is important to maintain the material, such as polycarbonate, in a molten state as it flows into and through a mold cavity space. Additionally, the shear stress profile of the flow of resin is desirably monitored and managed to insure proper filling of the cavity space. If the molten resin solidifies too rapidly when it encounters a cold mold, it may not penetrate narrow cavities, and/ or may form weak knit lines where two flows intersect.

Blow Molding

In blow molding, a thermoplastic tube called a parison is extruded or injection molded. The hot parison is then inserted in a cold mold, and air or another gas is forced into the parison causing it to expand to fill the mold. This technique is commonly used in the manufacturing of plastic bottles. In this technique, the cold mold limits the fineness of detail that can be achieved since the polymer freezes upon making contact with the walls of the mold. Thus, only crude features are currently obtainable in blow-molded products.

Rotational Molding

Rotational molding is useful for the production of hollow containers. A powdered polymer is placed in the mold, and the mold is heated. After the polymer has melted, the mold is rotated and cooled. As the mold is rotated, the molten polymer coats the surface of the mold, creating a hollow container in the shape of the mold. Cooling the mold allows the polymer to solidify. Heating and cooling the mold results in the process having long cycle times. Additionally, if the mold cools non-uniformly, then flaws may develop in the molded product.

Accordingly, much effort has been directed towards improving heat management and flow control in molding processes.

### SUMMARY OF THE INVENTION

The present invention features a metallic resistive heater and uses thereof. The resistive heater includes a metallic component that is electrically conductive (i.e., has low resistivity) and an oxide, nitride, carbide, silicide, and/or boride derivative of the metal component that is electrically insulating (i.e., has high resistivity). The resistivity is controlled in part by controlling the amount of oxide, nitride, carbide, silicide, and boride formation during the deposition of the metal component and the derivative. The resistive heater has numerous industrial and commercial applications (e.g., production of molded thermoplastic parts, paper, and semiconductor wafers).

Accordingly, in a first aspect, the invention features a resistive layer that includes a metallic component and one or more oxide, nitride, carbide, silicide, and/or boride derivatives of the metallic component. The invention further features a resistive heater in which the resistive layer is coupled to a power supply, wherein the application of current from the power supply to the resistive layer results in production of heat by the resistive layer.

In another aspect, the invention features a method of fabricating a resistive layer. The method includes the steps of providing a substrate, a metallic component feedstock, and a reactant that includes one or more of oxygen, nitrogen, carbon, silicon, and boron; melting the feedstock to produce a stream of molten droplets; reacting the molten droplets with the reactant to produce one or more oxide, nitride, carbide, silicide, or boride derivatives of the metallic component, wherein a portion of the metallic component reacts with the reactant to produce one or more derivatives and a portion of the metallic component remains unreacted; and depositing the unreacted metallic component and its oxide, nitride, carbide, silicide, and/or boride derivatives onto the substrate to produce a resistive layer. The method may further include connecting the resistive layer to a power supply to produce a resistive heater. The invention further features a resistive layer and a heater made by the methods above.

In another aspect, the invention features a mold that includes a mold cavity surface, which contacts the material to be molded, and a coating containing a resistive layer. The coating is disposed on at least a portion of the cavity surface. In one embodiment, the resistive layer includes a metallic component and one or more of its oxide, nitride, carbide, silicide, and/or boride derivatives. The mold may also include a runner, wherein the coating is disposed on at least a portion of the surface of the runner that contacts the material to be molded. Desirably, the mold includes a cooling jacket, e.g., located within a shell, a housing, a substrate in which a heater is disposed, or within a separate part of the mold.

In still another aspect, the invention features a method of making a molded product. This method includes the steps of providing a mold as described above; heating the resistive heater; injecting a material to be molded in the mold cavity, e.g., a thermoplastic, thermoset, or metal material, into the mold, wherein the heated resistive heater regulates solidification of the material, thereby forming the molded product. The method may also include cooling the material in the mold, e.g., by flowing a fluid through a cooling jacket. The invention further features a molded product produced by the above-described method.

In another aspect, the invention features a cylindrical roller including an outer surface, an inner surface surrounding a hollow core, and a resistive heater including a resistive layer as described above coupled to a power source. The resistive heater is disposed on the outer surface or the inner surface of the roller.

In yet another aspect, the invention features a method of drying paper. This method includes the steps of providing paper having a water content of greater than about 5% and one or more cylindrical rollers, described above; heating the roller with the resistive heater; and contacting the paper with the roller for a time suitable for drying the paper to a water content of less than about 5%.

The invention further features a semiconductor wafer processing system including an enclosure defining a reaction chamber; a support structure mounted within the reaction chamber, the support structure mounting a semiconductor wafer to be processed within the chamber; and a resistive heater comprising a resistive layer of the invention coupled to a power source, wherein the heater is disposed on a surface of said reaction chamber. In one embodiment, a heater is placed on the top of the reaction chamber such that one side (typically polished) of a wafer may be placed adjacent to or in contact with the heater. In another embodiment, a heater is placed on the bottom of the chamber such that one side (polished or unpolished) of a wafer may be placed adjacent to or in contact with the heater. In yet another embodiment, heaters are placed on the top and the bottom of the chamber.

The invention also features a method for heating a semiconductor wafer including the steps of providing a semiconductor wafer and a semiconductor wafer processing system of the invention; and heating the wafer with the resistive heater.

In yet another aspect, the invention features an impellor including two or more blades; a resistive layer of the invention disposed on one or more of the blades and coupled to a power supply; and a shaft connected to the blades and optionally connected to a motor, wherein the motor is capable of rotating the blades by rotating the shaft.

In another aspect, the invention features a method of fabricating a resistive heater on a substrate. The method includes the steps of providing a substrate coated with a resistive layer; forming an electrically isolated, resistive heater path in the resistive layer; and connecting the resistive heater path to a power supply, thereby fabricating a resistive heater. The forming may be, e.g., by micromachining, microabrading, laser cutting, chemical etching, or e-beam etching. In one embodiment, the substrate coated with a resistive layer is produced by providing a substrate, a metallic component feedstock, and a reactant comprising one or more of oxygen, nitrogen, carbon, silicon, and boron; melting the feedstock to produce a stream of molten droplets; reacting the molten droplets with the reactant to produce one or more of its oxide, nitride, carbide, silicide, or boride derivatives, wherein a portion of the metallic component reacts with the reactant to produce the oxide, nitride, carbide, silicide, and/or boride derivative and a portion of the metallic component remains unreacted; depositing the unreacted metallic component and its oxide, nitride, carbide, silicide, and/or boride derivative onto the substrate to produce a resistive layer.

In another aspect, the invention features an array of heaters including at least two resistive heaters. Each of these resistive heaters includes a resistive layer coupled to a power source, and each of the resistive layers may include a metallic component and one or more of its oxide, nitride, carbide, silicide, and/or boride derivatives. The elements of the array may be arranged in a regular or irregular geometric pattern. All or a portion of the elements may be independently controllable, i.e., power is supplied to one or more elements independently of the others. At least a portion of one heater may be disposed between at least a portion of a second heater and a substrate.

In another aspect, the invention features a thermocouple including a first thermally sprayed layer (e.g., iron) in electrical contact with a second thermally sprayed layer (e.g., constantan), wherein the difference in the thermoelectric voltages of the first and second layers is temperature dependent. In one embodiment, two or more thermocouples are arranged as an array of thermal sensors. A thermocouple may be connected to a voltmeter. At least a portion of an array of thermocouples may be independently coupled to a voltmeter. The thermocouples may be arrayed on a surface such as a nonconductive surface, e.g., glass, plastic, or nonconductive ceramic, or a surface coated with an electrically insulating layer, e.g., a thermally sprayed layer of aluminum oxide. The thermocouples may also be detachable from a surface.

The invention further features a method of making an array of thermocouples that includes the steps of applying a plurality of regions of a first material on a surface; applying a plurality of regions of a second material to produce a plurality of electrical junctions between the first and second materials; and providing electrical connections to each of the regions of the first material and to each of the regions of the second material, wherein the difference in the thermoelectric voltages of the first and second materials is indicative of the temperature of the surface. In desirable embodiments, the regions of the first or second material or both are applied by thermal spray. In one embodiment, the regions of the second material are applied on the surface. The method may further include step (d) coating the surface (and the deposited thermocouples) with an electrically insulating material.

In another aspect, the invention features a method of making an array of thermocouples. The method includes the steps of coating a substrate with a first layer of electrically conductive material; defining a first set of contacts in the first layer of electrically conductive material; applying a first thermocouple material on a portion of each of the first set of contacts to form a plurality of first thermocouple deposits, wherein a portion of the first set of contacts remains exposed; applying an electrically insulating layer to a portion of each of the first thermocouple deposits, wherein a portion of each of the first deposits remains exposed; applying a second thermocouple material to produce a plurality of second thermocouple deposits, wherein the first and second thermocouple deposits form a plurality of electrical junctions; applying an electrically insulating layer to the exposed portions of the first set of contacts; coating the plurality of second deposits and the electrically insulating layer with a second layer of electrically conductive material; and defining a second set of contacts in the second layer of electrically conductive material, wherein the difference in the thermoelectric voltages of the first and second materials is indicative of the temperature of the surface. In various embodiments, the first thermocouple deposit includes iron and the second thermocouple deposit includes constantan. In other embodiments, the layers and materials are deposited through masks. The defining of layers may include micromachining, microabrading, laser cutting, chemical etching, e-beam etching, or removing a mask. In desirable embodiments, some or all of the materials or layers are applied by thermal spray.

In another aspect, the invention features a combined array including an array of resistive heaters and an array of thermocouples, as described above.

In various embodiments of the above aspects, the resistive layer may have a microstructure that resembles a plurality of flattened discs or platelets having an outer region of nitride, oxide, carbide, silicide and/or boride derivatives of the metallic component, and an inner region of the metallic component. Substrates, on which resistive layers are disposed, include, e.g., metal, plastic, graphite, glassy carbon, glass, ceramic, or mica. The substrate may be, e.g., a mold, a roller, or a platen for semiconductor wafer processing. Although an electrical connection to a power supply is necessary for the production of heat, the heaters described above may be decoupled from the power supply.

In various embodiments of any of the foregoing aspects, the resistive layer has a resistivity of 10⁻⁴ to 10²⁰ Ω·cm (e.g., greater than 0.0001, 0.001, 0.002, 0.003, 0.005, 0.01, 0.1, 1, 10, 10², 10³, 10⁴, 10⁵, or 10⁶ Ω·cm and less than 10²⁰, 10¹⁵, 10¹⁰, 10⁶, 10⁵, 10⁴, 10³, 10², 10, or 1 Ω·cm), and the application of current from the power supply to the resistive layer results in production of heat by the resistive layer. Desirably, when the derivative is an oxide, e.g., when the metallic component is Fe, Cr, Ni, Si, Nb, Sn, Pb, or Cu, the resistive layer has a resistivity of greater than 2×10⁻³ Ω·cm. Preferably, the resistive layer is capable of generating a sustained temperature of greater than 200° F., 350° F., 400° F., 500° F., 1200° F., or 2200° F. In various other embodiments, the resistive heater includes an electrically insulating layer (e.g., a layer including aluminum oxide, silicon dioxide, porcelain, which may or may not be roughened, epoxy, or an oxidized region of the resistive layer) between the substrate and the resistive layer; an adhesion layer (e.g., one including nickel-chrome alloy or nickel-chrome-aluminum-yttrium alloy) between the insulating layer and the substrate, a thermal barrier layer (e.g., a layer including zirconium oxide) between the resistive layer and the substrate, a ceramic layer (e.g., one including aluminum oxide), which may be sealed with nanophase materials, e.g., nanophase aluminum oxide, superficial to the resistive layer, and/or a metallic layer (e.g., one including molybdenum or tungsten or one that is machineable) superficial to the resistive layer. Desirably, the metallic component of the resistive heater is titanium (Ti), silicon (Si), aluminum (Al), zirconium (Zr), cobalt (Co), nickel (Ni), iron (Fe), or alloys or combinations thereof. Other suitable metallic components are described herein. In certain embodiments, a resistive layer further includes boron. The resistive layers of the invention may also include a ceramic or cermet, e.g., one that is co-deposited with the metallic component.

In various embodiments of the methods of making resistive layers above, the melting step and the reacting step are coordinated such that the resistive layer has a resistivity of 10⁻⁴ to 10⁶ Ω·cm. The reactant may be a solid, liquid, or gas, and the metallic component feedstock may include the reactant. Molten droplets used in the methods described above may have an average diameter of 5 to 500 μm, 5 to 100 μm, 5 to 250 μm, 5 to 350 μm, 10 to 100 μm, 20 to 80 μm, 100 to 500 μm, or 100 to 250 μm. The substrate may be heated to within ±10, 20, or 50° F. of a temperature at which the heater is to be operated during deposition of the resistive layer.

A particular embodiment of the invention includes the use of insulating layers positioned above or below the heater to insulate the resistive layer electrically from adjacent, electrically conductive components. Additional layers can be added to reflect or emit heat from the heater in a selected pattern. One or more layers can also be included to provide improved thermal matching between components to prevent bending or fracture of different layers having different coefficients of thermal expansion. Layers that improve the adhesion between layers and the substrate may also be used.

By “metallic component” is meant a metal, metalloid, or composite thereof capable of forming an oxide, carbide, nitride, silicide, and/or boride by reaction with a gas, liquid, or solid.

By “metallic component feedstock” is meant a feedstock including at least one metallic component in a physical form suitable for use in thermal spraying. Exemplary physical forms include, without limitation, wire, powder, rods, and ingots. The feedstock may also include one or more materials, e.g., a liquid or a solid, that react with the metallic component during thermal spraying.

Exemplary metallic components include, without limitation, transition metals such as titanium (Ti), vanadium (V), cobalt (Co), nickel (Ni), iron (Fe), and transition metal alloys; highly reactive metals such as magnesium (Mg), zirconium (Zr), hafnium (Hf), and aluminum (Al); refractory metals such as tungsten (W), molybdenum (Mo), and tantalum (Ta); metal composites such as aluminum/aluminum oxide and cobalt/tungsten carbide; and metalloids such as silicon (Si).

By “reactant” is meant one or more chemical species in solid, liquid, or gas form that include one or more of oxygen, nitrogen, carbon, silicon, and boron. The reactant may or may not be in the form of a mixture of the physical forms or dissolved or suspended in a liquid.

By “substrate” is meant any object on which a resistive layer is deposited. The substrate may be, e.g., bare metal, plastic, glass, graphite, glassy carbon, mica, or ceramic, or it may have one or more layers, e.g., an electrically insulating layer, on its surface.

By “thermoplastic material” is meant a material capable of softening or fusing when heated and of hardening again when cooled. Exemplary thermoplastic materials include thermoplastic organic polymers. A “thermoplastic melt” is the softened or molten thermoplastic material.

By “thermoset material” is meant a material that irreversibly transforms from a liquid to a solid by chemical reaction upon exposure to heat. Examples of thermoset materials include thermoset epoxies and silicones.

By “cycle time” is meant the time elapsed between a certain point in one cycle and that same point in the next cycle. For example, the cycle time for injection molding is measured as the time between injections of thermoplastic melt into a mold.

By “runner” is meant a channel that transports a thermoplastic melt from an entrance to a mold to the cavity.

By “cooling jacket” is meant a channel or cavity or series thereof through which a cooling liquid or gas flows. The cooling jacket may be disposed proximal to a heater of the invention or proximal to a surface of a mold cavity.

By “thermal barrier” layer or element is meant a layer or element that prevents heat flow. Examples of thermal barrier elements are heat reflective and thermally insulating elements.

By “heat reflective” layer or element is meant a layer or element that has a low thermal emissivity, a low thermal absorptivity, and high thermal reflectivity. A heat reflective layer reduces heat loss from radiative transfer. Heat reflective elements are known to those skilled in the art.

By “thermally insulating layer or element is meant a layer or element that has a low thermal conductivity (typically about 0.01 to 5 W/m·K, e.g., about 2 W/m·K). A thermally insulating layer reduces heat loss by conduction. Thermally insulating elements are known to those skilled in the art.

By “thermocouple” is meant a device for measuring temperature in which two dissimilar metals (as copper and iron) are joined and connected to an instrument (as a voltmeter) that measures the difference in potential created at the junction of the two metals

By “thermoelectric voltage” is meant the electrical potential generated in a material in response to a temperature gradient (the Seebeck effect).

Other features and advantages will be apparent from the description of the preferred embodiments, and from the claims.

### BRIEF DESCRIPTION OF THE DRAWINGS

FIG. 1 is an illustration of an HVOF wire system 2 that uses metal wire 4 as feedstock and combustion of fuel gases 6 for melting the feedstock. A carrier gas 8 reacts with the molten feedstock and transports the molten droplets to a substrate 10 to produce a layer 12.

FIG. 2 is an illustration of a plasma spray system 100 that uses metal powder 110 as feedstock and generates an argon 120/hydrogen 130 plasma to melt the powder. Another reactant gas 140 is supplied to the molten droplets through a nozzle 150. The molten droplets are deposited as a layer 160 on a substrate 170.

FIG. 3 is an illustration of a spray deposited resistive heater designed for the inside surface of a roller 200. A resistive layer 210 is deposited in a pattern of rings for the production of resistive heaters that heat in parallel.

FIG. 4 is an illustration of a cross section of an injection mold including a resistive heater. The surface of a metal mold 300 includes several layers: an adhesion layer 310, an electrically and thermally insulating layer 320, a metallic resistive layer 330, an electrically insulating and thermally conducting layer 340, and a metal layer 350. A terminal 360, insulated from the mold by a terminal insulator 370, connects the resistive layer to a power supply.

FIG. 5A is a top view of an array of thermocouples.

FIG. 5B is a cross-sectional view of a deposited thermocouple.

FIG. 5C is a top view of an array of resistive heaters and thermocouples.

FIG. 5D is a cross-sectional view of a deposited resistive heater in an array.

FIG. 6A is a top view of an array of thermocouples.

FIG. 6B is a cross-sectional view of a deposited thermocouple.

FIG. 6C is a top view of an array of resistive heaters and thermocouples.

FIG. 6D is a cross-sectional view of a deposited resistive heater in an array.

### DETAILED DESCRIPTION

We have discovered a metallic resistive layer (and methods of making the same) that includes a metallic component that is electroconductive and an oxide, nitride, carbide, silicide, and/or boride derivative of the metallic component that is electrically insulating. We have further discovered that this resistive layer, when coupled to a power supply, functions as a heater.

To deposit a layer that will generate heat when a voltage is applied, the layer must have a resistance that is determined by the desired power level. The resistance, R, is calculated from the applied voltage, V, and the desired power level, P, from:

R=V²/P

The resistance is related to the geometry of the heater coating—the electric current path length, L, and the cross sectional area, A, through which the current passes—and also to the material resistivity, ρ, by the equation:

R=ρL/A

Therefore, to design a layer for a given power level and a given geometry that will operate at a given voltage, one has only to determine the resistivity of the material by:

ρ=R A/L=V ²A/PL

In the present invention, the resistivity is controlled in part by controlling the amount of oxide, nitride, carbide, silicide, and boride formation during the deposition of the metallic component.

That the resistivity is a controlled variable is significant because it represents an additional degree of freedom for the heater designer. In most situations, the resistivity of the heater material, e.g., nichrome, is a fixed value. In such an instance, the heater designer must arrange the heater geometry (L and A) to obtain the desired power. For example, if it is desired to heat a tube by winding nichrome wire around it, the designer must choose the correct diameter wire for A, the cross sectional area through which the electric current must pass, and the spacing of the windings for L, the total path length of the electric current.

We now described the resistive layer and its use as a resistive heater.

Metallic Components and Oxides, Nitrides, Carbides, Silicides, and Borides Thereof

Metallic components of the invention include any metal or metalloid except boron that is capable of reacting to form a carbide, oxide, nitride, silicide, boride, or combination thereof. Exemplary metallic components include, without limitation, transition metals such as titanium (Ti), vanadium (V), cobalt (Co), nickel (Ni), iron (Fe), and transition metal alloys (such as an FeCrAl alloy, e.g., 72.2% Fe, 22% Cr, 5.8% Al); highly reactive metals such as magnesium (Mg), zirconium (Zr), hafnium (Hf), and aluminum (Al); refractory metals such as tungsten (W), molybdenum (Mo), and tantalum (Ta); metal composites such as aluminum/aluminum oxide and cobalt/tungsten carbide; and metalloids such as silicon (Si). These metallic components typically have a resistivity in the range of 1−100×10⁻⁶ Ω·cm. During the coating process (e.g., thermal spraying), a feedstock (e.g., powder, wire, or solid bars) of the metallic component is melted to produce droplets and exposed, e.g., to a gas containing oxygen, nitrogen, carbon, silicon, and/or boron. This exposure allows the molten metallic component to react with the gas to produce an oxide, nitride, carbide, silicide, or boride derivative, or combination thereof, on at least a portion of the surface of the droplet.

The nature of the reacted metallic component is dependent on the amount and nature of the reactant used in the deposition. For example, use of pure oxygen results in an oxide of the metallic component. In addition, a mixture of oxygen, nitrogen, and carbon dioxide results in a mixture of oxide, nitride, and carbide. The exact proportion of each depends on intrinsic properties of the metallic component and on the proportion of oxygen, nitrogen, and carbon in the gas. The resistivity of the layers produced by the methods herein range from 100−1,000,000×10⁻⁶ Ω·cm.

Exemplary species of oxide include TiO₂, TiO, ZrO₂, V₂O₅, V₂O₃, V₂O₄, CoO, Co₂O₃, CoO₂, Co₃O₄, NiO, FeO, Fe₂O₃, Fe₃O₄, MgO, HfO₂, Al₂O₃, WO₃, WO₂, MoO₃, MoO₂, Ta₂O₅, TaO₂, and SiO₂. Examples of nitrides include TiN, VN, Ni₃N, Fe₂N, Fe₄N, Mg₃N₂, ZrN, AlN, and Si₃N₄. Desirable carbides include TiC, VC, Fe₃C, MgC₂, Mg₂C₃, HfC, Al₄C₃, WC, Mo₂C, TaC, and SiC. Silicides include, for example, TiSi₂, Ti₅Si₃, VSi₂, V₃Si, CoSi₂, Ni₂Si, NiSi₂, FeSi₂, Mg₂Si, ZrSi₂, HfSi₂, Al₄Si₃, W₅Si₃, WSi₂, MoSi₂, TaSi₂, and Ta₅Si₃. Exemplary borides include TiB, TiB₂, VB₂, Ni₂B, Ni₃B, FeB, AlB₂, TaB, TaB₂, SiB, and ZrB₂. Other oxides, nitrides, carbides, suicides, and borides are known by those skilled in the art.

Reactants

In order to obtain oxides, nitrides, carbides, suicides, or borides of a metallic component, the reactant that is reacted with the component must contain oxygen, nitrogen, carbon, silicon, and/or boron. The reactant may be in the form of a gas, liquid, or solid. Reactant gases may, for example, be used to generate a plasma or flame or accelerate molten droplets. A reactant liquid may be part of the feedstock, for example, as the liquid in a metallic component slurry or in a liquid-core wire or bead. Liquid reactants also include solutions of dissolved or suspended reactants. A reactant solid may be combined with the metallic component, for example, as a mixture of powders or as a formed wire, rod, or ingot.

A liquid or solid reactant may be injected into the molten flux of the thermal spray apparatus separately from the metallic component. Upon introduction into the molten flux, a liquid may vaporize, and a solid may melt or vaporize. Exemplary gases include oxygen, nitrogen, carbon dioxide, boron trichloride, ammonia, methane, silane, disilane, dichlorosilane, tetrachlorosilane, and diborane. Examples of liquid reactants include alcohols, alkanes, carboxylic acids, ammonium hydroxide, amines, silanes, silicones, aqueous hydrogen peroxide, boron tribromide, and trifluoroboron etherate. Examples of reactant solids include ceramic oxides, carbides, nitrides, silicides, and borides, carbonates, silicates, borates, nitrates, and azides. Other gases, liquids, and solids are known by those skilled in the art.

Thermal Spray

The resistive layers and other layers of a coating of the present invention are desirably deposited using a thermal spray apparatus. Exemplary thermal spray apparatuses include, without limitation, arc plasma, flame spray, ROKIDE® systems (Norton, Worcester, Mass.), arc wire, and high velocity oxy-fuel (HVOF) systems.

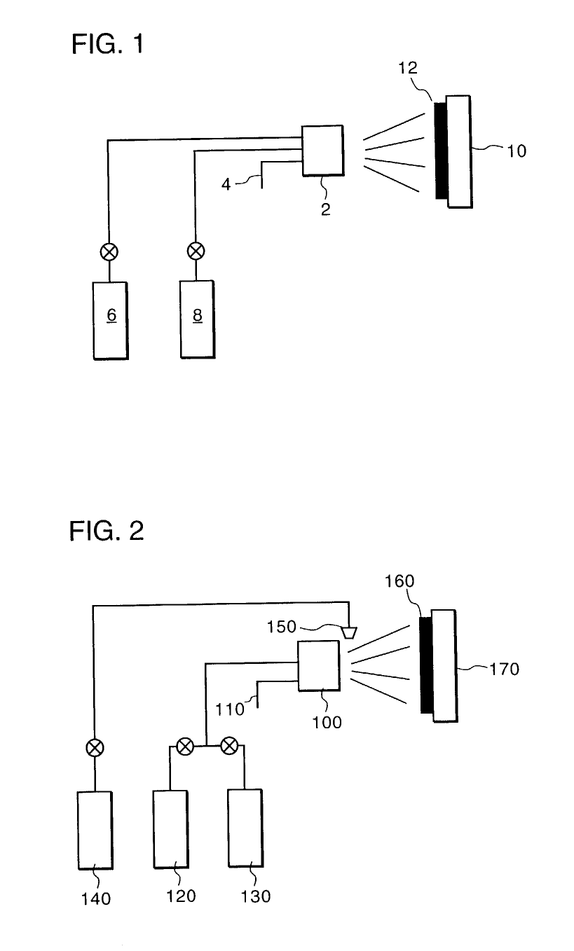

A typical HVOF wire system consists of a gun or spray head where three separate gases come together (see FIG. 1). Propane gas and oxygen are commonly used as fuel gases, and a gas, e.g., chosen as the reactant, is used to accelerate the molten droplets and cool the spray nozzle in the gun. Normally, this last function is accomplished through the use of air. The gases are fed to the spray head through flow meters and pressure regulators or through mass flow controllers so that there is a controlled, independent flow for each gas. If it is desired to deliver reduced amounts of reactant gas, it can be mixed with an inert gas, for example, argon, so that the volume and flow are sufficient to operate the gun at appropriate velocities. The mixing may be accomplished by flowmeters and pressure regulators, mass flow controllers, or by the use of pre-mixed cylinders, each of which is generally known to a practitioner skilled in the art. The feedstock, which is wire in this case, is supplied to the gun head by means of a wire feeder that controls the rate at which material is delivered to the gun. The gun itself may be attached to a motion control system such as a linear translator or multiaxis robot.

The thermal spray apparatus is desirably configured so that a reactant gas, liquid, or solid may be injected into the molten flux stream of the spray. For combustion systems and arc wire systems, the injection of a gas may be accomplished by using the gas as the accelerator. For plasma systems, if the plasma gases do not serve also as the reaction gas, a reactant gas may be injected using an additional nozzle (FIG. 2). Solids and liquids may also be injected via additional nozzles. Incorporating additional nozzles for injection of reactants is also applicable to other systems.

The composition of the deposited layer may be influenced by the type of thermal spray apparatus used. For example, droplets are emitted very rapidly from an HVOF system in comparison to other techniques, and these droplets are consequently exposed to reactants for a shorter period of time and thus react to a lesser extent. In addition, layers deposited by HVOF have higher adhesion strength than layers deposited by other systems.

Resistive layers of the invention may be deposited on any suitable substrate. Exemplary substrates include metals, plastics, ceramics, mica, and glass. A resistive layer may also be deposited on another layer, e.g., a bonding or electrically insulating layer. The surface of the substrate may also be roughened, e.g., by grit blasting, prior to depositing a resistive layer.

Patterned Layers

Resistive layers may be deposited in defined patterns on a substrate. The pattern may be defined, for example, by a removable mask or tape. Other masking techniques include the use of dissolvable protective coatings, e.g., photoresist. Patterned application allows for the fabrication of more than one spatially separated resistive layer on one or more substrates. Patterned layers also allow controlled heating in localized areas of a substrate.

A layer may also be patterned by outlining a heater by cutting or scribing a path in a resistive layer, e.g., by using commercially available microabrading equipment (e.g., from Comco Inc, Burbank, Calif. or S.S. White Technologies, Piscataway, N.J.). In microabrading, a blaster emitting an abrasive powder, e.g., aluminum oxide or silicon carbide, is used to abrade material in a defined area. Coupling the blaster to a multiaxis robot translator or motion controller enables the outlining of specific geometries, e.g., a resistive path, on a coated surface. A resistive path outlined by microabrading is electrically isolated from the remainder of a deposited resistive layer. Microabrading can be controlled to cut through only one layer, e.g., the resistive layer, while keeping other layers, e.g., an electrically insulating layer, intact. Microabrading eliminates the need for masking during deposition.

Similar patterning can be obtained using micromachining (e.g., cutting with a diamond cutting tool), laser cutting, chemical etching, e-beam etching, and other techniques known in the art.

Microstructure

The characteristic lamellar microstructure of a coating deposited by thermal spray is a direct result of the process. The thermal spray process creates from the feedstock a flux of molten droplets, which are accelerated and directed towards the substrate. The droplets, typically moving at speeds of several hundred meters per second, impact the substrate and very rapidly cool at rates approaching one million degrees per second. This rate of cooling causes very rapid solidification. Nevertheless, during the impact, the droplets deform into platelet-like shapes and stack on top of each other as the spray head is traversed back and forth across the substrate to build up the coating. The microstructure thus assumes a layered configuration, with the flattened particles all aligned parallel to the substrate and perpendicular to the line of deposition. Typically, the deposited layers have a thickness of about 0.001″-0.100″.

If the material being deposited undergoes no reactions in the flux stream, then the composition of the coating is identical to that of the feedstock. If, however, the molten droplets react during the deposition process, the composition of the coating differs from that of the feedstock. The droplets may acquire a surface coating of the reaction product, which varies in thickness depending, for example, on the rate of reaction, the temperatures encountered, and the concentration of the reactant. In some cases, the droplets react completely; in other cases, the droplets have a large volume fraction of unreacted feedstock, e.g., a free metal, at their centers. The resulting microstructure of the coating is a lamellar structure, one consisting of individual particles of complex composition. The coating has a reduced volume fraction of unreacted feedstock, e.g., free metal, with the remainder consisting of reaction products distributed in general as material surrounding the unreacted feedstock contained in each platelet-like particle.

When reactants are added to the flux stream to form reaction products, which have a much higher electrical resistivity than the metallic component, the resultant coating exhibits a bulk resistivity that is higher than the free metallic component. In addition, when the concentration of reactant is controlled, thereby controlling the concentration of reaction product, the resistivity of the coating is controlled proportionately. For example, the resistivity of aluminum sprayed in pure oxygen is higher than that sprayed in air because there is a higher concentration of aluminum oxide in the layer sprayed in oxygen, and aluminum oxide has very high resistivity.

The substrate may be heated during deposition to within ±10, 20, or 50° F. of the operating temperature of the heater. Once cooled, the resistive layer is in a state of compression and less prone to delamination from the substrate.

Spatially Variable Resistivity

The invention also provides methods for producing a coating having a resistivity that is variable, e.g., a continuous gradient or step function, as a function of location on a substrate. For example, the resistivity of the layer may increase or decrease by 50, 100, 200, 500, or 1000% over a distance of 1, 10, or 100 cm. The apparatus used includes a thermal spray gun and a reactant source. The reactant source includes two or more solids, liquids, or gases that can be mixed in any arbitrary combination. By controlling the composition of the reactant used in the thermal spray gun, the composition, and therefore resistivity, of the coating is controlled. For example, a gradual increase in a reactant gas (e.g., oxygen) leads to a gradual increase in the resistivity of the coating. This gradual increase can be used to produce a coating having a gradient of resistivity on a substrate. Similarly, other patterns, e.g., step functions, of resistivity may be formed by appropriate control of the mixture of reactants. The mixture of reactants may include more than one reactive species (e.g., nitrogen and oxygen) or a reactive and an inert species (e.g., oxygen and argon). A computer may also be used to control the mixing of the reactants. Systems for mixing reactants together are known in the art.

Electrically Insulating Layers

The resistive layer is separated from a conductive substrate or layer, e.g., a metal layer, by an electrically insulating layer. This layer may, for example, include a non-conductive ceramic, mica, a non-conductive polymer, such as epoxy, or a glassy layer, such as a porcelain layer. These insulating layers may be deposited, e.g., by thermal spray, screen printing, painting, or casting from solution. For example, an epoxy layer may be screen printed on a metal substrate, and a metal powder can be pressed into the surface of the wet epoxy to serve as a bond layer for the resistive layer. Examples of electrically insulating ceramics that may be thermally sprayed on a conductive substrate include aluminum oxide, zirconium oxide, steatite, and magnesium oxide.

In another embodiment, a metal substrate is porcelainized using standard techniques, for example, coating the substrate with a powder and heating the powder to between 1200 and 1400° F. to melt the porcelain. Porcelain may be applied to a substrate, for example, by dip coating or screen-printing. Exemplary substrates for porcelain are steel, electroless nickel, and aluminum. The exact type of porcelain is determined by factors, such as the type of substrate, the operating temperature of the heater, and desired chemical or physical properties. One skilled in the art can make this determination. Typically surfaces to be thermally sprayed are roughened, e.g., by grit blasting, for better adhesion of the deposited layer, but layers may be thermally sprayed on porcelain without roughening.

The resistive layer may also be coated with an electrically insulating layer to isolate it from conducting layers deposited on top of the resistive layer. In one embodiment, a resistive layer, e.g., one containing silicon or zirconium, is treated, e.g., to oxidize its surface, to render its surface electrically and/or thermally insulating. Resistive layers may be deposited on a nonconducting surface without an electrically insulating layer, e.g., titanium compounds deposited on glass.

Additional Layers

Layers may be deposited on a substrate to provide properties other than heat generation. These additional layers may be deposited by thermal spray or by other techniques such as screen printing or deposition from a solution. Examples of additional layers include, without limitation, an adhesion layer (e.g., nickel-aluminum alloy), an electrical contact layer (e.g., copper or conductive porcelain), a thermally insulating layer (e.g., zirconium dioxide), a thermally emissive coating (e.g., chromium oxide), layers for improved thermal matching between layers with different coefficients of thermal expansion (e.g., nickel between aluminum oxide and aluminum), a thermally conductive layer (e.g., molybdenum), a machineable metal layer (e.g., tungsten), and a heat reflective layer (e.g., tin). These layers may be located between the resistive layer and the substrate (e.g., adhesion layers) or on the side of the resistive layer distal to the substrate. The thermally sprayed layers may also be sealed by a dielectric sealant, such as a silicone, glass-filled silicone, ceramic, or nanophase material.

Applications

A resistive layer is made into a resistive heater by electrically coupling a power supply to the layer. Application of a current through the resistive layer then generates heat resistively. Connections between the power supply and the resistive layer are made, for example, by brazing connectors, soldering wires, physical contact using various mechanical connectors, or by any other means known in the art. These resistive heaters are advantageous in applications where localized heating is desired.

A. Molding. One application of a resistive heater of the invention is in injection molding. An injection mold has a cavity into which a melt of a thermoplastic or metal is forced. Once the material cools and hardens, it can be removed from the mold, and the process can be repeated. An injection mold of the invention has a coating containing a resistive heating layer on at least a portion of the surface of the cavity. The resistive heating layer may be covered with an electrically insulating layer, which is coated with a metal layer (e.g., molybdenum or tungsten). The purpose of placing a heater layer in the cavity of a mold and in the conduits to that cavity is to better control the solidification process and reduce cycle times. Heaters in close proximity to the melt can be used to keep the melt hot so that it flows better with less pressure, and to cool the melt during the solidification phase in a controlled way. Heated molds will allow thin-walled parts to be produced, since a thermoplastic or metal will not freeze upon being injected into a heated mold. An example of a thin-walled part is a magnesium cell phone housing. The reduction in pressure required to inject a material in a heated mold allows for lower clamping pressures in injection molding machines and for the molding of larger parts or multiple smaller parts in a single mold. Exemplary materials for molds include nickel or other metals that have been electroplated, electroless plated, forged, molded, or thermally sprayed.

Resistive heaters of the invention may also be employed in blow molding. A resistive heater on the interior surface of a blow mold can be heated to enable the production of hollow plastic parts with fine detail since the polymer will not freeze when contacted with a heated mold.

Molds for other molding techniques may also contain resistive layers proximal to the surface of the mold. These techniques include, without limitation, rotational molding, pressure forming, vacuum forming, flash molding, thixotropic molding, and reactive injection molding. Materials that can be molded include thermoplastic materials, thermoset materials, metals, glasses, green cermets, ceramics, and fluoropolymers. Heaters of the invention can maintain thermoplastics or metals in a molten shape until they have completely filled a mold, i.e., the heaters can maintain a mold at a temperature equal to or greater than the melting point of a particular material.

Heaters of the invention can also be used to cure thermoset materials after they have been inserted in a mold. In one embodiment, a solid form having a resistive heating layer deposited on its surface is dipped in a thermoset material, current is applied to generate heat, and the thermoset material hardens around the mold. The hardened thermoset material may then be ejected from the mold, which is reusable. The duration of heating determines the thickness of the molded part.

In one embodiment, the heater of the present invention may be used in an injection molding system to manage and control the flow of the molten material throughout the mold cavity space. The heater may be deposited as part of a coating directly on the surface of the mold cavity area to manage the temperature profile in the moving, molten material precisely. For some applications, the heater may have variable resistivity across the surface of the mold cavity area to allow for fine adjustments to the molten material temperature gradient, thus providing precise heat flow control and constant (or precisely-managed) viscosity and velocity of the melt flow. Mold heat management and flow control depend on the specific application and the type of material used.

Desirably, the heater is used in conjunction with a thermal sensor (e.g., a thermistor or thermocouple) and/or a pressure sensor. Direct deposit of the coating containing the heater onto the mold cavity area can reduce or eliminate air gaps between the heater and the heated surface, providing intimate and direct contact for improved temperature transfer between the heater and the heated surface.

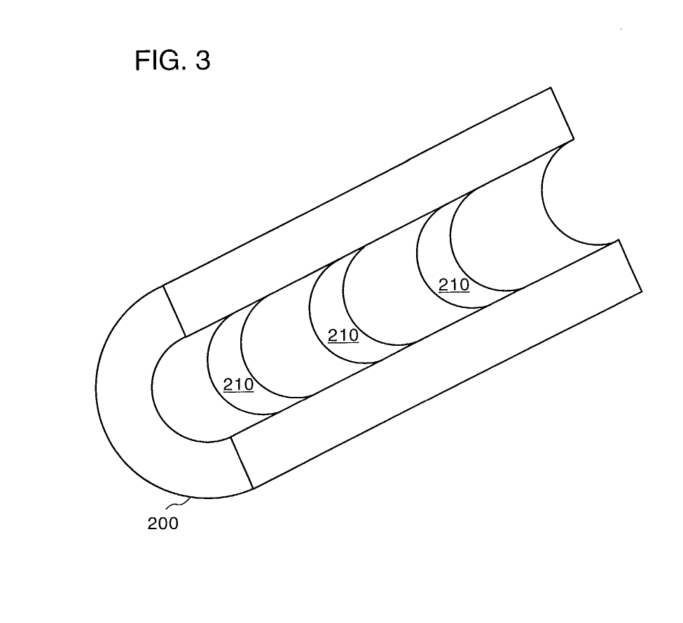

B. Heated rollers. Heated rollers are used in many industries including the papermaking, printing, laminating, and paper, film, and foil converting industries. One application of a resistive heater of the invention is in dryers in paper manufacturing (see FIG. 3). Paper is manufactured in several stages, including forming, pressing, and drying. The drying stage typically removes water remaining from the pressing stage (typically about 30%) and reduces the water content typically to less than about 5% (e.g., less than 4-6%). The drying process typically involves contacting both sides of the paper with heated cylindrical rollers. Accordingly, a roller for a paper dryer having a resistive heater layer may be produced by methods of the invention. A coating containing a resistive heater layer is deposited on the interior or exterior of such a roller. Other coatings such as anticorrosive coatings may also be applied. The heater may be applied in a defined pattern through masks in the deposition step. For instance, a pattern of zones that concentrates heat at the ends of the roller provides a more uniform heat to the paper since the ends cool more quickly than the center of the roller. Examples of rollers that contain heating zones are given in U.S. Pat. No. 5,420,395, hereby incorporated by reference.

The deposited resistive heaters may be applied to a dryer can (or roller) used in the paper making process to remove water from pulp. In one example, the heaters are applied to the inside surface of a steel roller or can. First, an insulator layer of aluminum oxide is applied by thermal spray and sealed with nanophase aluminum oxide or some other suitable high temperature dielectric sealant. Then, the resistive heater layer is deposited using a high velocity oxy-fuel wire spray system, titanium wire, and nitrogen gas. The terminals are secured to the inside of the can by welding or threaded studs and are insulated such that electrical power may be applied to the deposited resistive layer. Finally, the entire heater layer is coated with high temperature silicone or another layer of thermally sprayed aluminum oxide, which is sealed as before.

Alternatively, the heater layer and insulator layers may be applied to the outside surface of the dryer can and coated with a thermally sprayed metallic layer, such as nickel. The nickel is then ground back to the desired dimension. For smaller heated roll applications, a metal casing may be affixed or shrunk onto the roll with its heaters applied.

C. Semiconductor wafer processing system. Heaters are also used in semiconductor wafer processing (see WO 98/51127, hereby incorporated by reference). A semiconductor wafer processing system of the invention includes a chamber, one or more resistive heaters, and means for mounting and manipulating a semiconductor wafer. The system may be used in wafer processing applications such as annealing, sintering, silicidation, and glass reflow. A system including such a heater is also useful for promoting reactions between wafers and reactive gases, for example, oxidation and nitridation. In addition, the system may be used for epitaxial reactions, wherein a material such as silicon is deposited on a heated surface in monocrystalline form. Finally, such a system allows chemical vapor deposition of the product of a gas phase reaction in noncrystalline form on a heated substrate.

D. Impellor. Heaters of the invention may be deposited on an impellor by the methods described herein. Electrical connectivity to the heater can be made via wires contained inside or on the surface of a shaft on which the impellor is mounted. The shaft may be connected to a motor to provide rotation. The impellor is, for example, coated with additional layers to provide chemical or abrasion resistance. Such an impeller can be used in a compact space heater with no separate heating coils, since the heating element is attached to the fan blades. This configuration provides better heat transfer to the air, and the fan blades act as heat radiators.

Additional applications of the heaters of the invention are as follows:

1. Blanket heater on pipe with metal contact layer on top and aluminum oxide insulator on the contact;

2. Heater tip for natural gas ignitor on kitchen stove, oven, water heater or heating system;

3. Free standing muffle tube fabricated by sprayforming on a removable mandrel;

4. Low voltage heater coating for bathroom deodorizer;

5. Laboratory applications: Resistively heated coated glass and plastic lab vessels; work trays; dissection trays; cell culture ware; tubing; piping; heat exchangers; manifolds; surface sterilizing laboratory hoods; self-sterilizing work surfaces; sterilizing containers; heatable filters; frits; packed beds; autoclaves; self-sterilizing medical bacterial and tissue culture tools (e.g., loops and spreaders); incubators; benchtop heaters; flameless torches; lab ovens; incinerators; vacuum ovens; waterbaths; drybaths; heat platens; radiography pens; reaction vessels; reaction chambers; combustion chambers; heatable mixers and impellers; electrophoresis equipment; anode and cathode electrodes; heating electrodes; electrolysis and gas generation systems; desalinization systems; de-ionizing systems; spectroscopy and mass spectroscopy equipment; chromatography equipment; HPLC; IR sensors; high temperature probes; thermoplastic bags; cap and tube sealers; thermal cyclers; water heaters; steam generation systems; heated nozzles; heat activated in-line valves; shape-memory alloy/conductive ceramic systems; lyophilizers; thermal ink pens and printing systems;

6. Medical and dental applications: Self-sterilizing and self-cauterizing surgical tools (e.g., scalpel blades, forceps); incubators; warming beds; warming trays; blood warming systems; thermally controlled fluid systems; amalgum heaters; dialysis systems; phoresis systems; steamer mops; ultra high temperature incineration systems; self sterilizing tables and surfaces; drug delivery systems (e.g., medicated steam inhaler; thermal activated transcutaneal patches); dermatological tools; heatable tiles; wash basins; shower floors; towel racks; mini-autoclaves; field heater cots; body warming systems;

7. Industrial applications: Sparkless ignition systems; sparkless combustion engines; bar heaters; strip heaters; combustion chambers; reaction chambers; chemical processing lines; nozzles and pipes; static and active mixers; catalytic heating platforms (e.g., scrubbers); chemical processing equipment and machines; environmental remediaton systems; paper pulp processing and manufacturing systems; glass and ceramic processing systems; hot air/air knife applications; room heaters; sparkless welding equipment; inert gas welding equipment; conductive abrasives; heater water-jet or liquid-jet cutting systems; heated impellors and mixing tanks; fusion and resistance locks; super heated fluorescent bulbs that use new inert gases; heatable valves; heatable interconnects and interfaces of all types; heatable ceramics tiles; self heating circuit boards (e.g., self-soldering boards; self-laminating boards); fire hydrant heaters; food processing equipment (e.g., ovens, vats, steaming systems, searing systems, shrink wrapping systems, pressure cookers, boilers, fryers, heat sealing systems); in-line food processing equipment; programmable temperature grids and platens to selectively apply heat to 2-D or 3-D structures (e.g., thermoplastic welding and sealing systems); point pulsing heaters; battery operated heaters; inscribers and marking systems; static mixers; steam cleaners; IC chip heaters; LCD panel heaters; condensers; heated aircraft parts (e.g., wings, propellers, flaps, ailerons, vertical tail, rotors); conductive ceramic pens and probes; self-curing glazes; self-baking pottery; walk-in-ovens; self-welding gaskets; heat pumps;

8. Home and office applications: Heatable appliances of all types; self cleaning ovens; igniters; grills; griddles; susceptor-based heatable ceramic searing systems for microwaves ovens; heated mixers; impellors; stirrers; steamers; crock pots; pressure cookers; electric range tops; refrigerator defrost mechanisms; heated ice cream scoops and serving ladles; operated hand held heaters and warmers; water heaters and switches; coffee heater systems; heatable food processors; warmable toilet seats; towel racks; clothes warmers; bodywarmers; cat beds; instantly heated irons; water bed heaters; washers; driers; faucets; heated bathtubs and wash basins; dehumidifiers; hose nozzles for heated washing or steam cleaning; platens to heat moisturized wipes; bathroom tissue heaters; towel heaters; heated soap dispensers; heated head razors; evaporative chilling systems; self-heating keys; outdoor CO₂ and heat generating systems for bug attraction and killing systems; aquarium heaters; bathroom mirrors; chair warmers; heatable blade ceiling fans; floor heaters;

9. Whole surface geometric heaters; direct contact heaters; pure ceramic heating systems; coated metal heating systems; self-detecting fault systems; plasma sprayed thermocouples and sensors; plasma spheredized bed reaction systems (e.g., boron gas generation system for the semiconductor industry; heatable conductive chromatographic beds and beads systems); pre-heaters to warm surfaces prior to less costly or more efficient heating methods; sensors (e.g., heater as part of integrated circuit chip package);

10. Microwave and electromagnetic applications: Magnetic susceptor coatings; coated cooking wear; magnetic induction ovens and range tops;

11. Thermoplastic manufacturing applications: resistively heated large work surfaces and large heaters; heated injection molds; tools; molds; gates; nozzles; runners; feed lines; vats; chemical reaction molds; screws; drives; compression systems; extrusion dies; thermoforming equipment; ovens; annealing equipment; welding equipment; heat bonding equipment; moisture cure ovens; vacuum and pressure forming systems; heat sealing equipment; films; laminates; lids; hot stamping equipment; shrink wrapping equipment;

12. Automotive applications: Washer fluid heaters; in-line heaters and nozzle heaters; windshield wiper heaters; engine block heaters; oil pan heaters; steering wheel heaters; resistance-based locking systems; micro-catalytic converters; exhaust scrubbers; seat heaters; air heaters; heated mirrors; heated key locks; heated external lights; integral heater under paint or in place of paint; entry and exit port edges; sparkless “sparkplugs”; engine valves, pistons, and bearings; mini-exhaust catalytic pipes;

13. Marine applications: antifouling coatings; de-iceable coatings (e.g., railings, walkways); electrolysis systems; desalinization systems; on-board seafood processing systems; canning equipment; drying equipment; ice drills and corers; survival suits; diving suit heaters; desiccation and dehumidifying systems;

14. Defense applications: High temperature thermal targets and decoys; remora heaters; MRE heating systems; weapons preheaters; portable heaters; cooking devices; battery powered heatable knife; noncombustion based gas expansion guns; jet de-icing coating on wings etc; thermal fusion self destruction systems; incinerators; flash heating systems; emergency heating systems; emergency stills; desalinization and sterilization systems;

15. Signage applications: heated road signs, thermoresponsive color changing signs; inert gas (e.g., neon) impregnated microballoons that fluoresce in magnetic fields;

16. Printing and photographic applications: copiers; printers; printer heaters; wax heaters; thermal cure ink systems; thermal transfer systems; xerographic and printing heaters; radiographic and photographic film process heaters; ceramic printers;

17. Architectural applications: heated walkway mats, grates, drains, gutters, downspouts, and roof edges;

18. Sporting applications: heated golf club heads; bats; sticks; handgrips; heated ice skate edges; ski and snowboard edges; systems for de-icing and re-icing rinks; heated goggles; heated glasses; heated spectator seats; camping stoves; electric grills; heatable food storage containers.

The following examples are presented merely to illustrate various embodiments of the invention and are not meant to limit the invention in any way.

### EXAMPLE 1

### Injection Mold

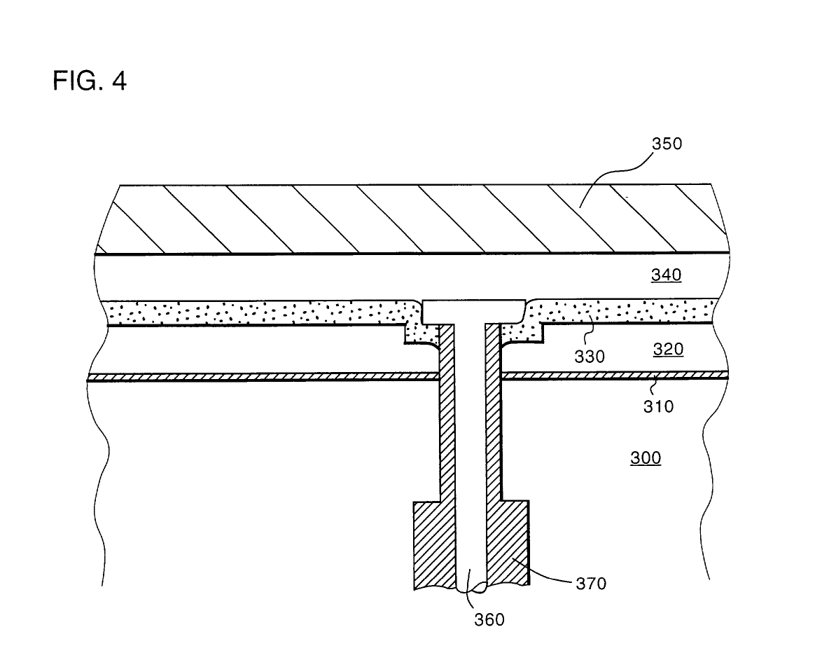

The heater is applied to the mold cavity of a plastics mold (see FIG. 4). First, a NiCrAlY alloy adhesion (or bond) coat is applied to the cavity to a thickness of about 0.002″ using a High Velocity Oxy-Fuel Wire (HVOF) thermal spray system. Next a zirconium oxide layer measuring 0.012″ is applied with an arc plasma spray system. The zirconium oxide electrically and thermally insulates the heater from the steel mold, which is water cooled. A resistive heater layer is applied next as a coating of material 0.008″ thick on top of the zirconium oxide. Zirconium is deposited using a HVOF thermal spray system using propane and oxygen for the fuel gases to melt the metal wire and pure nitrogen as an accelerator. The nitrogen promotes formation of zirconium nitride in the molten flux and boosts the resistivity of the coating from 0.00007 Ω·cm for pure zirconium to 0.003 Ω·cm for the deposited coating. Next, micromachining using aluminum oxide media and controlled via a multiaxis robot is used to delineate the desired heater element pattern on the mold. A second 0.015″-thick layer of ceramic electrical insulator is then applied to the top of the heater. Aluminum oxide is chosen for this layer because it has a higher thermal conductivity than zirconium oxide. The aluminum oxide is applied using an arc plasma system and is then sealed with nanophase aluminum oxide. Zirconium terminals are inserted at this stage through holes machined in the mold. They are inserted to make electrical contact with the heater layer. Finally, a metal layer of tungsten is applied to a thickness of 0.040″ by arc plasma spray and machined back to the desired dimension. The mold cavity is completed by electroplating a layer of nickel on top of the tungsten.

### EXAMPLE 2

### Array of Thermal Sensors

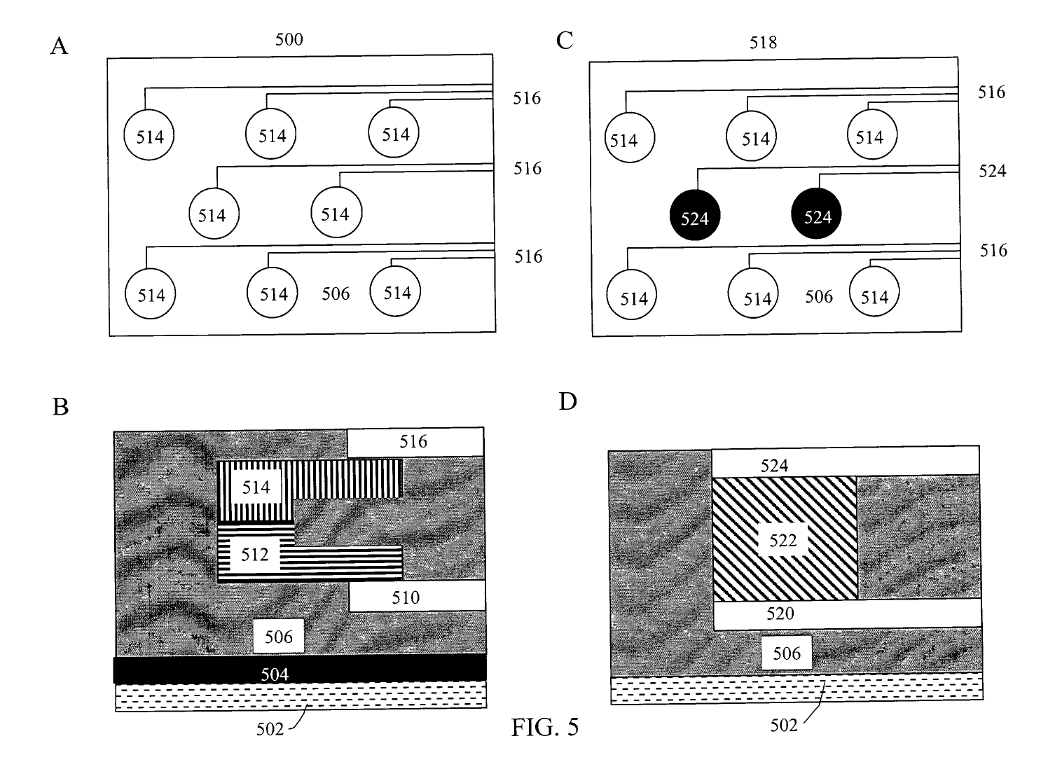

An array 500 of thermal sensors may be fabricated to monitor the temperature of a heater of the invention, as depicted in FIGS. 5A and 5B. A resistive heating layer 504 on a substrate 502 is coated with aluminum oxide 506. A layer of copper is then thermally sprayed over the aluminum oxide and patterned into an array of copper contacts 508 by microabrading. Layers of iron (or an iron containing alloy, e.g., steel) 512 are thermally sprayed onto the surface, and then layers of constantan (copper and nickel alloy) 514 are thermally sprayed to form an electrical junction 510 between portions of the iron and constantan layers (see FIG. 5B). Appropriate masks are used to define the areas on which materials are deposited, and layers of aluminum oxide are deposited as needed to provide electrical isolation, e.g., between portions of the iron and constantan layers. A second layer of copper is thermally sprayed over the surface and patterned into a second set of contacts 516 to produce the array of thermal sensors. A protective layer of aluminum oxide may (as depicted in FIG. 5B) or may not be deposited on the exposed constantan 514 present after micromachining contacts 516.

Alternatively, the iron component of the thermocouple may comprise a steel substrate or the deposited materials may be CHROMEL® (nickel with 10% chrome) and ALUMEL® (nickel with up to 5% aluminum) or any other pair of materials that have different thermoelectric voltages in response to a temperature gradient.

### EXAMPLE 3

### Array of Heaters and Thermal Sensors

An array of heaters may be fabricated to provide localized control of heating, and an array of thermal sensors may be employed for temperature sensing, as depicted in FIGS. 5C and 5D. Such a combined array 518 is fabricated as follows. A metal mold 502 is coated by thermal spray with a layer of aluminum oxide 506 for electrical insulation. A layer of copper is then sprayed over the aluminum oxide. Two sets of contacts 508 and 520 are then defined using microabrading, as described above. Zirconium is thermally sprayed in air onto the contacts 520 using an appropriate mask to produce an array of resistive elements 522 in electrical contact with copper contacts 520. An iron-constantan thermocouple 512, 514 is then deposited on contacts 508 as in Example 2. A layer of copper is applied to the surface after appropriate insulating layers have been deposited. The copper is then patterned by microabrading to produce a set of contacts 524 for the resistive elements 522 and a set of contacts 510 for the thermocouples 512, 514. Protective layers of aluminum oxide may or may not be deposited after the contacts 510, 524 have been formed. Passing a current through the resistive element via the contact pads produces heat in the resistive element. Each element can be individually controlled, or all of the elements can be controlled in unison. Thermocouples are arranged such that they can be used to sense the temperature of the mold in proximity to each element of the heater array. The combined arrays are used to produce and monitor the heat profile of the surface of the mold.

### EXAMPLE 4

### Alternative Array of Thermal Sensors

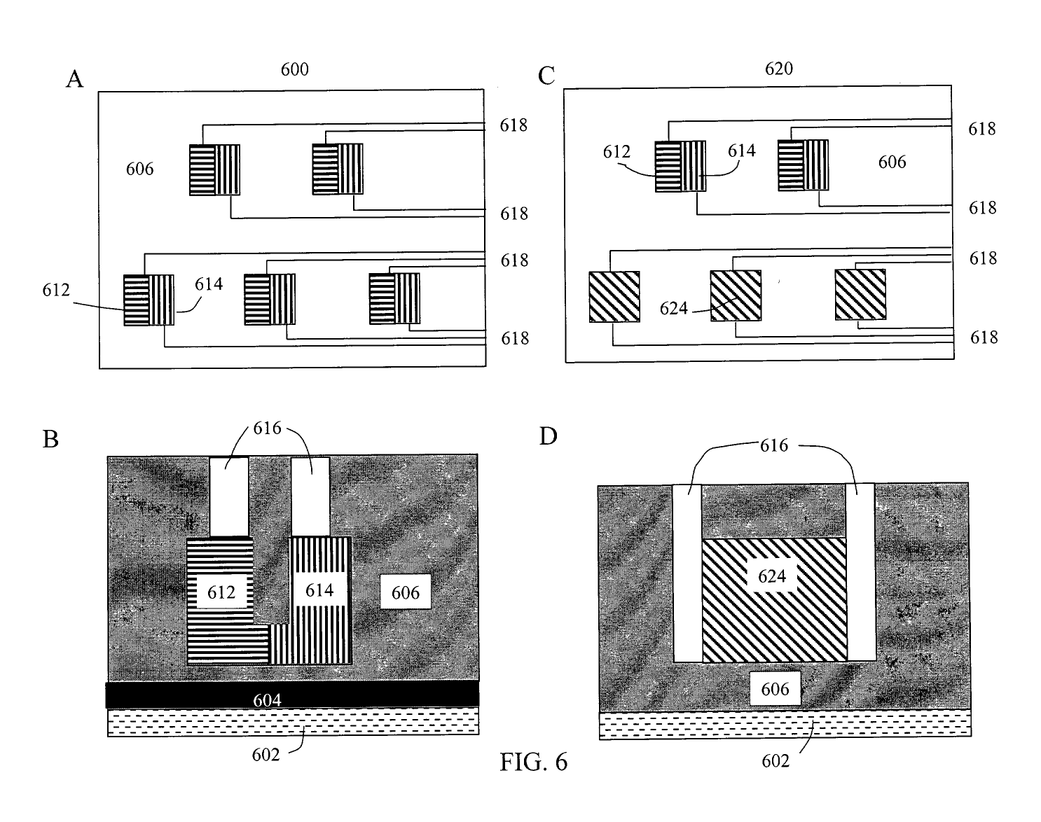

In an alternative embodiment to the array described in Example 2, an array 600 of thermal sensors may be fabricated to monitor the temperature of a heater of the invention, as depicted in FIGS. 6A and 6B. A resistive heating layer 604 on a substrate 602 is coated with aluminum oxide 606. A layer of iron (or an iron containing alloy, e.g., steel) 612 is thermally sprayed onto the surface in discrete areas. A layer of constantan 614 is then thermally sprayed onto the surface in discrete areas adjacent to the iron deposits 612 to produce an array of iron-constantan junctions. Additional layers of iron and constantan are then deposited on portions of those layers previously deposited to form a thermocouple. These additional layers are not in physical contact with one another (FIG. 6B). Copper contacts are deposited on the iron and the constantan portions of the thermocouple to provide electrical contacts 616. Appropriate masks are used to define the areas on which material is deposited. A layer of aluminum oxide 606 may (as depicted) or may not be thermally sprayed over the surface to provide electrical isolation and protection. Any aluminum oxide covering the ends of the copper contacts may be removed, e.g., by grit blasting. Wires 618 to provide electrical connections to the copper contacts 616 are then added by methods known in the art, e.g., soldering.

### EXAMPLE 5

### Alternative Array of Heaters and Thermal Sensors

In an alternative embodiment, an array of heaters may be fabricated to provide localized control of heating, and an array of thermal sensors may be employed for temperature sensing, as depicted in FIGS. 6C and 6D. Such a combined array 620 is fabricated as follows. A substrate 602 is coated by thermal spray with a layer of aluminum oxide 606 for electrical insulation. Iron-constantan thermocouples are then deposited as in Example 4. A layer of zirconium is thermally sprayed in air onto the surface in discrete areas to form resistive elements 622. A layer of copper is then thermally sprayed onto the surface in an area on each iron deposit 612, an area on each constantan deposit 614, and two areas adjacent to the zirconium 622 deposits. The surface now has an array of resistive elements 622 in electrical contact with one set of copper contacts 616 and an array of thermocouples in electrical contact with a second set of copper contacts 616. Appropriate masks are used to define the areas where material is deposited. A layer of aluminum oxide 606 may (as depicted in FIGS. 6A and 6B) or may not then be deposited onto the surface, and any aluminum oxide covering the ends of the copper contacts is removed. Wires 618 to provide electrical connections to the copper contacts 616 are then added by methods known in the art, e.g., soldering. Passing a current through the resistive element via the contact pads produces heat in the resistive element. Each element can be individually controlled, or all of the elements can be controlled in unison. Thermocouples are arranged such that they can be used to sense the temperature of the mold in proximity to each element of the heater array. The combined arrays are used to produce and monitor the heat profile of the surface of the mold.

### EXAMPLE 6

### Thin Resistive Heater

A thin resistive heater of the invention may be fabricated by depositing a resistive layer directly on an electrically conducting surface and applying an electrically conductive layer superficial to the resistive layer. The path length for current flow is now the thickness of the deposited layer. In this example, a resistivity of greater than 1 Ω·cm, e.g., >10³, 10⁴, or 10⁵ Ω·cm, may be desirable to obtain a heater with a resistance capable of producing adequate heat power.

### EXAMPLE 7

### Multiple Layers of Heaters

One or more heaters of the invention may be formed on top of one or more other heaters of the invention. Two or more heaters of the invention may also be formed in an interlacing or basket weave pattern. The resistive layers in such a stack of heaters are separated by electrically insulating layers. Each individual heater may have a different shape or thickness than any other heater in a stack. The heaters may be operated independently of one another. For example, in a stack of two heaters, one heater may be used to produce a constant amount of heat while the second heater may be operated for short durations of time (e.g., pulsed) to temporarily boost the temperature of an area, e.g., the entire surface being heated or a portion thereof.

### EXAMPLE 8

### Combination Resistive Heaters

Resistive layers of the invention may be formed by a combination of reacting a metallic component with a reactant as described herein and adding a conductive or resistive ceramic or cermet. A ceramic or cermet is mixed, e.g., as a powder, with the reactive metallic component and thermally sprayed in air to form a resistive layer including the metallic component, derivatives of the metallic component, and the ceramic or cermet.

### Other Embodiments

All publications, patents, and patent applications mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in thermal spraying, coatings, thermoplastics, or related fields are intended to be within the scope of the invention.

Other embodiments are in the claims.

What is claimed is:

1. A resistive heater comprising a resistive layer coupled to a power source, said resistive layer comprising a metallic component and one or more oxide, nitride, carbide, silicide, and/or boride derivatives of said metallic component, wherein said resistive layer has a resistivity of 10⁻⁴ to 10⁶ Ω·cm, wherein application of current from said power supply to said resistive layer results in production of heat by said resistive layer, and wherein when said resistive layer comprises an oxide derivative, said resistivity is greater than 2×10⁻³ Ω·cm.

2. The resistive heater of claim 1, wherein said resistive layer further comprises boron.

3. The resistive heater of claim 1, wherein said resistive layer further comprises a ceramic or cermet.

4. The resistive heater of claim 1, wherein said resistive heater is disposed on a substrate.

5. The resistive heater of claim 4, further comprising an electrically insulating layer between said substrate and said resistive layer.

6. The resistive heater of claim 5, wherein said insulating layer comprises aluminum oxide or silicon dioxide.

7. The resistive heater of claim 5, further comprising an adhesion layer between said insulating layer and said substrate.

8. The resistive heater of claim 7, wherein said adhesion layer comprises nickel-chrome alloy or nickel-chrome-aluminum-yttrium alloy.

9. The resistive heater of claim 5, wherein said electrically resistive layer comprises porcelain.

10. The resistive heater of claim 9, wherein said electrically resistive layer comprising porcelain is not roughened.

11. The resistive heater of claim 5, wherein said electrically resistive layer comprises epoxy.

12. The resistive heater of claim 1, further comprising a thermal barrier layer between said resistive layer and said substrate.

13. The resistive heater of claim 12, wherein said thermal barrier layer comprises zirconium oxide.

14. The resistive heater of claim 1, further comprising a ceramic layer superficial to said resistive layer.

15. The resistive heater of claim 14, wherein said ceramic layer comprises aluminum oxide.

16. The resistive heater of claim 15, wherein said ceramic layer is sealed with nanophase aluminum oxide.

17. The resistive heater of claim 1, further comprising a metallic layer superficial to said resistive layer.

18. The resistive heater of claim 17, wherein said metallic layer comprises molybdenum or tungsten.

19. The resistive heater of claim 1, wherein said substrate is a mold, a roller, or a platen for semiconductor wafer processing.

20. The resistive heater of claim 1, wherein said metallic component is titanium (Ti), silicon (Si), aluminum (Al), zirconium (Zr), cobalt (Co), nickel (Ni), iron (Fe), vanadium (V), tantalum (Ta), tungsten (W), molybdenum (Mo), hafnium (Hf), or alloys thereof.

21. The resistive heater of claim 1, further comprising a layer of machineable metal superficial to said resistive layer.

22. The resistive heater of claim 1, further comprising an electrically resistive layer comprising an oxidized region of said resistive layer.

23. The resistive heater of claim 3, wherein said substrate comprises metal, plastic, graphite, glassy carbon, glass, ceramic, or mica.

24. A resistive heater on a substrate, produced by the method comprising the steps of:
a) providing a substrate, a metallic component feedstock, and a reactant comprising one or more of oxygen, nitrogen, carbon, silicon, and boron;
b) melting said feedstock to produce a stream of molten droplets;
c) reacting said molten droplets with said reactant to produce one or more oxide, nitride, carbide, silicide, or boride derivatives of said metallic component, wherein a portion of said metallic component reacts with said reactant to produce said oxide, nitride, carbide, suicide and/or boride derivative of said metallic component and a portion of said metallic component remains unreacted;
d) depositing said unreacted metallic component and said oxide, nitride, carbide, silicide, and/or boride derivatives of said metallic component onto said substrate to produce a resistive layer; and
e) connecting said resistive layer of step (d) to a power supply, thereby producing a resistive heater,
wherein said resistive layer has a resistivity of 10⁻⁴ to 10⁶ Ω·cm, and wherein when said resistive layer comprises an oxide derivative, said resistive layer has a resistivity of greater than 2×10⁻³ Ω·cm.

25. The resistive heater of claim 24, wherein said molten droplets have an average diameter of 5 to 500 μm.

26. The resistive heater of claim 24, wherein said resistive layer further comprises boron.

27. A method of fabricating a resistive heater on a substrate, said method comprising the steps of:
a) providing a substrate, a metallic component feedstock, and a reactant comprising one or more of oxygen, nitrogen, carbon, silicon, and boron;
b) melting said feedstock to produce a stream of molten droplets;
c) reacting said molten droplets with said reactant to produce one or more oxide, nitride, carbide, silicide, or boride derivatives of said metallic component, wherein a portion of said metallic component reacts with said reactant to produce said oxide, nitride, carbide, silicide, and/or boride derivative of said metallic component and a portion of said metallic component remains unreacted;
d) depositing said unreacted metallic component and said oxide, nitride, carbide, suicide, and/or boride derivative of said metallic component onto said substrate to produce a resistive layer; and
e) connecting said resistive layer of step (d) to a power supply, thereby fabricating a resistive heater, wherein said melting step (b) and said reacting step (c) are coordinated such that the resistive layer of step (d) has a resistivity of 10⁻⁴ to 10⁶ Ω·cm, and wherein when said resistive layer comprises an oxide derivative, said resistive layer has a resistivity of greater than 2×10⁻³ Ω·cm.

28. The method of claim 27, wherein said molten droplets of step (b) have an average diameter 5 to 500 μm.

29. The method of claim 27, further comprising step (f) applying a ceramic layer superficial to said resistive layer, wherein step (f) is performed before, during, or after step (e).

30. The method of claim 29, further comprising step (g) applying a metallic layer superficial to said ceramic layer, wherein step (g) is performed before, during, or after step (e).

31. The method of claim 27, wherein said substrate is an injection mold, a roller, or a platen for semiconductor wafer processing.

32. The method of claim 27, wherein said metallic component is titanium (Ti), silicon (Si), aluminum (Al), or zirconium (Zr), cobalt (Co), nickel (Ni), iron (Fe), vanadium (V), tantalum (Ta), tungsten (W), molybdenum (Mo), hafnium (Hf), or alloys thereof.

33. The method of claim 27, wherein in step (d), said substrate is heated to within ±10, 20, or 50° F. of a temperature at which said heater is operated during deposition of said resistive layer.

34. The method of claim 27, wherein said reactant comprises a gas.

35. The method of claim 27, wherein said reactant comprises a solid.

36. The method of claim 27, wherein said reactant comprises a liquid.

37. The method of claim 27, wherein said metallic component feedstock comprises said reactant.

38. The method of claim 27, wherein step (d) further comprises depositing a ceramic or cermet with said unreacted metallic component and said derivative of said metallic component.

39. A mold comprising a mold cavity surface and a coating comprising a resistive layer, said coating being disposed on at least a portion of said surface, wherein application of current from a power supply to said resistive layer results in production of heat by said resistive layer.

40. The mold of claim 39, wherein said resistive layer comprises a metallic component and one or more oxide, nitride, carbide, silicide, and/or boride derivatives of said metallic component, wherein said resistive layer has a resistivity of 10⁻⁴ to 10⁶ Ω·cm.

41. The mold of claim 39, wherein said coating further comprises an electrically insulating layer between said cavity surface and said resistive layer.

42. The mold of claim 41, wherein said coating further comprises an adhesion layer between said cavity surface and said insulating layer.

43. The mold of claim 39, wherein said coating further comprises a thermal barrier layer between said resistive layer and said substrate.

44. The mold of claim 39, wherein said coating further comprises a ceramic layer superficial to said resistive layer.

45. The mold of claim 39, wherein said coating further comprises a metallic layer superficial to said resistive layer.

46. The mold of claim 39, further comprising a runner, wherein said coating is disposed on at least a portion of a surface of said runner.

47. A method of making a molded product, said method comprising the steps of:
a) providing an injection mold comprising a cavity surface and a coating comprising a resistive heater coupled to a power supply, said coating disposed on at least a portion of said cavity surface, whereby application of current from said power supply to said resistive layer results in production of heat by said resistive layer;
b) heating said resistive heater; and
c) injecting a material to be molded into said mold, wherein said heated resistive heater regulates solidification of said material, thereby forming said molded product.

48. The method of claim 47, wherein said resistive heater in step (a) comprises a metallic component and one or more oxide, nitride, carbide, suicide, and/or boride derivatives of said metallic component, wherein said resistive heater has a resistivity of 10⁻⁴ to 10⁶ Ω·cm.

49. The method of claim 47, wherein said resistive heater is produced by a method comprising the steps of:
a) providing a metallic component feedstock and a reactant comprising one or more of oxygen, nitrogen, carbon, silicon, and boron;
b) melting said feedstock to produce a stream of molten droplets;
c) reacting said molten droplets with said reactant to produce one or more oxide, nitride, carbide, silicide, or boride derivatives of said metallic component, wherein a portion of said metallic component reacts with said reactant to produce said oxide, nitride, carbide, silicide, and/or boride derivatives of said metallic component, and a portion of said metallic component remains unreacted;
d) depositing said metallic component and said oxide, nitride, carbide, silicide, and/or boride derivatives of said metallic component to produce a resistive layer; and
e) connecting said resistive layer of step (d) to a power supply, thereby fabricating said resistive heater.

50. The method of claim 47, further comprising step (d) cooling said material.

51. The method of claim 50, wherein said material is a thermoplastic or metal.

52. A molded part produced by the method of claim 47.

53. A cylindrical roller comprising an outer surface, an inner surface surrounding a hollow core, and a resistive heater comprising a resistive layer coupled to a power source, said resistive layer comprising a metallic component and one or more oxide, nitride, carbide, silicide, and/or boride derivatives of said metallic component, wherein said resistive layer has a resistivity of 10⁻⁴ to 10⁶ Ω·cm, and wherein application of current from said power supply to said resistive layer results in production of heat by said resistive layer, wherein said resistive heater is disposed on said outer surface or said inner surface.

54. A method of drying paper during manufacturing comprising the steps of:
a) providing paper comprising a water content of greater than about 5% and one or more cylindrical rollers, each comprising an outer surface, an inner surface surrounding a hollow core, and a resistive heater comprising a resistive layer coupled to a power source, said resistive layer comprising a metallic component and one or more oxide, nitride, carbide, silicide, and/or boride derivatives of said metallic component, wherein said resistive layer has a resistivity of 10⁻⁴ to 10⁶ Ω·cm, and wherein application of current from said power supply to said resistive layer results in production of heat by said resistive layer, wherein said resistive heater is disposed on said outer surface or said inner surface;
b) heating said roller with said resistive heater; and
c) contacting said paper with said roller for a time suitable for drying said paper to a water content of less than about 5%.

55. A semiconductor wafer processing system comprising:
a) an enclosure defining a reaction chamber;
b) a support structure mounted within the reaction chamber, the support structure mounting a semiconductor wafer to be processed within said chamber; and
c) a resistive heater comprising a resistive layer coupled to a power source, said resistive layer comprising a metallic component and one or more oxide, nitride, carbide, suicide, and/or boride derivatives of said metallic component, wherein said resistive layer has a resistivity of 10⁻⁴ to 10⁶ Ω·cm, wherein application of current from said power supply to said resistive layer results in production of heat by said resistive layer, and wherein said heater is disposed on a surface of said reaction chamber.

56. A method for heating a semiconductor wafer comprising the steps of:
a) providing a semiconductor wafer and a semiconductor wafer processing system comprising:
i) an enclosure defining a reaction chamber;
ii) a support structure mounted within the reaction chamber, thesupport structure mounting a semiconductor wafer to be processed within said chamber; and
iii) a resistive heater comprising a resistive layer coupled to a power source, said resistive layer comprising a metallic component and one or more oxide, nitride, carbide, silicide, and/or boride derivatives of said metallic component, wherein said resistive layer has a resistivity of 10⁻⁴ to 10⁶ Ω·cm, and wherein application of current from said power supply to said resistive layer results in production of heat by said resistive layer; and
b) heating said wafer with said resistive heater.

57. An impellor comprising:
a) two or more blades;
b) a resistive layer disposed on one or more of said blades and coupled to a power supply, wherein said resistive layer comprising a metallic component and one or more oxide, nitride, carbide, silicide, and/or boride derivatives of said metallic component, wherein said resistive layer has a resistivity of 10⁻⁴ to 10⁶ Ω·cm, and wherein application of current from said power supply results in production of heat by said resistive layer; and
c) a shaft connected to said blades and optionally connected to a motor, wherein said motor is capable of rotating said blades by rotating said shaft.

58. A method of fabricating a resistive heater on a substrate, said method comprising the steps of:
a) providing a substrate, a metallic component feedstock, and a reactant comprising one or more of oxygen, nitrogen, carbon, silicon, and boron;
b) melting said feedstock to produce a stream of molten droplets;
c) reacting said molten droplets with said reactant to produce one or more oxide, nitride, carbide, silicide, or boride derivatives of said metallic component, wherein a portion of said metallic component reacts with said reactant to produce said oxide, nitride, carbide, suicide, and/or boride derivative of said metallic component and a portion of said metallic component remains unreacted;
d) depositing said unreacted metallic component and said oxide, nitride, carbide, silicide, and/or boride derivative of said metallic component onto said substrate to produce a resistive layer;
e) forming an electrically isolated, resistive heater path in said resistive layer by micromachining, microabrading, laser cutting, chemical etching, or e-beam etching; and
f) connecting said resistive heater path of step (e) to a power supply, thereby fabricating a resistive heater.

59. A resistive layer comprising a metallic component and one or more oxide, nitride, carbide, silicide, and/or boride derivatives of said metallic component, wherein said resistive layer has a resistivity of 10⁻⁴ to 10⁶ Ω·cm, wherein when said resistive layer comprises an oxide derivative, said resistivity is greater than 2×10⁻³ Ω·cm.

60. A method of fabricating a resistive layer on a substrate, said method comprising the steps of:
a) providing a substrate, a metallic component feedstock, and a reactant comprising one or more of oxygen, nitrogen, carbon, silicon, and boron;
b) melting said feedstock to produce a stream of molten droplets;
c) reacting said molten droplets with said reactant to produce one or more oxide, nitride, carbide, silicide, or boride derivatives of said metallic component, wherein a portion of said metallic component reacts with said reactant to produce said oxide, nitride, carbide, silicide, and/or boride derivative of said metallic component and a portion of said metallic component remains unreacted;
d) depositing said unreacted metallic component and said oxide, nitride, carbide, silicide, and/or boride derivative of said metallic component onto said substrate to produce said resistive layer,
wherein said melting step (b) and said reacting step (c) are coordinated such that the resistive layer of step (d) has a resistivity of 10⁻⁴ to 10⁶ Ω·cm, and wherein when said resistive layer comprises an oxide derivative, said resistive layer has a resistivity of greater than 2×10⁻³ Ω·cm.

61. An array of heaters comprising at least two resistive heaters, wherein each of said resistive heaters comprises a resistive layer coupled to a power supply, each of said resistive layers comprising a metallic component and one or more oxide, nitride, carbide, silicide, and/or boride derivatives of said metallic component, wherein said resistive layers have a resistivity of 10⁻⁴ to 10⁶ Ω·cm, and wherein application of current from said power supply to each of said resistive layers results in production of heat by each of said resistive layers.

62. The array of claim 61, wherein at least a portion of said heaters are independently coupled to said power supply.

63. The array of claim 61, further comprising a substrate, wherein at least a portion of one of said heaters is disposed between at least a portion of a second heater and said substrate.

64. A thermocouple comprising a first thermally sprayed layer in electrical contact with a second thermally sprayed layer, wherein the difference in the thermoelectric voltages of said first and second layers is temperature dependent.

65. An array of thermal sensors comprising at least two thermocouples, wherein each thermocouple comprises a first thermally sprayed layer in electrical contact with a second thermally sprayed layer, wherein the difference in the thermoelectric voltages of said first and second layers is temperature dependent.

66. The array of claim 65, wherein at least one of said thermocouples is independently connected to one or more voltmeters.

67. The array of claim 65, wherein said first layer comprises iron and said second layer comprises constantan.

68. A method of making an array of thermocouples, said method comprising the steps of:
(a) applying a plurality of regions of a first material on a surface;
(b) applying a plurality of regions of a second material to produce a plurality of electrical junctions between said first and second material; and
(c) providing electrical connections to each of said regions of said first material and to each of said regions of said second material,
wherein the difference in the thermoelectric voltages of said first and second materials is indicative of the temperature of said surface.

69. The method of claim 68, wherein said regions of said second material are deposited on said surface.

70. The method of claim 68, further comprising step (d) coating said surface with an electrically insulating material.

71. The method of claim 68, wherein said regions of said first material or of said second material are applied by thermal spray.

72. A method of making an array of thermocouples, said method comprising the steps of:
(a) coating a substrate with a first layer of electrically conductive material;
(b) defining a first set of contacts in said first layer of electrically conductive material;
(c) applying a first thermocouple material on a portion of each of said first set of contacts to form a plurality of first thermocouple deposits, wherein a portion of said first set of contacts remains exposed;
(d) applying an electrically insulating layer to a portion of each of said first thermocouple deposits, wherein a portion of each of said first deposits remains exposed;
(e) applying a second thermocouple material to produce a plurality of second thermocouple deposits, wherein said first and second thermocouple deposits form a plurality of electrical junctions;
(f) applying an electrically insulating layer to said first set of contacts;
(g) coating said plurality of second deposits and said electrically insulating layer with a second layer of electrically conductive material; and
(h) defining a second set of contacts in said second layer of electrically conductive material,
wherein the difference in the thermoelectric voltages of said first and second materials is indicative of the temperature of said surface.

73. The method of claim 72, wherein said first thermocouple deposit comprises iron and said second thermocouple deposit comprises constantan.

74. The method of claim 72, wherein in step (c), the first thermocouple material is applied through a mask.

75. The method of claim 72, wherein in step (d) or (f), said electrically insulating layer is applied through a mask.

76. The method of claim 72, wherein in step (e), said second thermocouple material is applied through a mask.

77. The method of claim 72, wherein said defining in steps (b) and (h) comprises micromachining, microabrading, laser cutting, chemical etching, or e-beam etching.

78. The method of claim 72, wherein in step (a), said first electrically conducting layer is applied through a mask, and wherein said defining in step (b) comprises removing said mask.

79. The method of claim 72, wherein in step (g), said second electrically conducting layer is applied through a mask, and wherein said defining in step (h) comprises removing said mask.

80. The method of claim 72, wherein at least one of said first or second electrically conducting layers, said electrically insulating layers of steps (d) and (f), or said first or second thermocouple material is applied using thermal spray.

81. A combined array comprising an array of claim 61 and an array of claim 65.
